(19) United States
(12) Patent Application Publication
(10) Pub. No.: US 2012/0206191 A1
(43) Pub. Date: Aug. 16, 2012

(54) EDGE RATE CONTROL (ERC) PRE-BIASING TECHNIQUE

(76) Inventor: William D. Llewellyn, San Jose, CA (US)

(21) Appl. No.: 13/177,019

(22) Filed: Jul. 6, 2011

Related U.S. Application Data
(60) Provisional application No. 61/441,713, filed on Feb. 11, 2011.

(51) Int. Cl. G05F 1/10

(52) U.S. Cl. 327/538

(57) ABSTRACT

This document discusses, among other things, apparatus and methods for pre-biasing an edge rate controlled output stage of a switch circuit. In an example, a switch circuit can include an output transistor and a pre-bias circuit coupled to the output transistor. The pre-bias circuit can include a pre-bias transistor configured to selectively couple a control node of the output device to a first voltage, and wherein the pre-bias transistor can include a lower threshold voltage than the output transistor.

### CLAIM OF PRIORITY

This patent application claims the benefit of priority, under 35 U.S.C. Section 119(e), to Llewellyn, U.S. Provisional Patent Application Serial No. 61/441,713, entitled “EDGE RATE CONTROL (ERC) PRE-BIASING TECHNIQUE,” filed on Feb. 11, 2011 (Attorney Docket No. 2921.111PRV), which is hereby incorporated by reference herein in its entirety.

### BACKGROUND

Presetting internal bias node voltages in anticipation of output transition events using selected, fixed voltages can help in the production of fast responding, clean, straight-line output voltage slewing behavior between power rails. However, such techniques do not take into account the magnitude of the load current and potential effects of the load current on the output edge. Failure to gain certain load current information can place the burden of maintaining proper control of the output, as it is pushed by the unknown load current, to the integration loop, which can result in an inconsistent, ragged, and current-dependent response.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-3 illustrate generally examples of edge rate control circuits.

### DETAILED DESCRIPTION

In an example, an edge rate-controlled switching output stage can produce a controlled slew rate under widely varying load conditions.

The present inventor has recognized, among other things, edge rate control apparatus and techniques that can reduce or eliminate the use of dead-reckoning for pre-biasing internal nodes, and can use load current information, such as actual magnitude of the load current to pre-bias key internal nodes. Such techniques can result in reduced power dissipation and cleaner transitions across a full range of load current magnitudes.

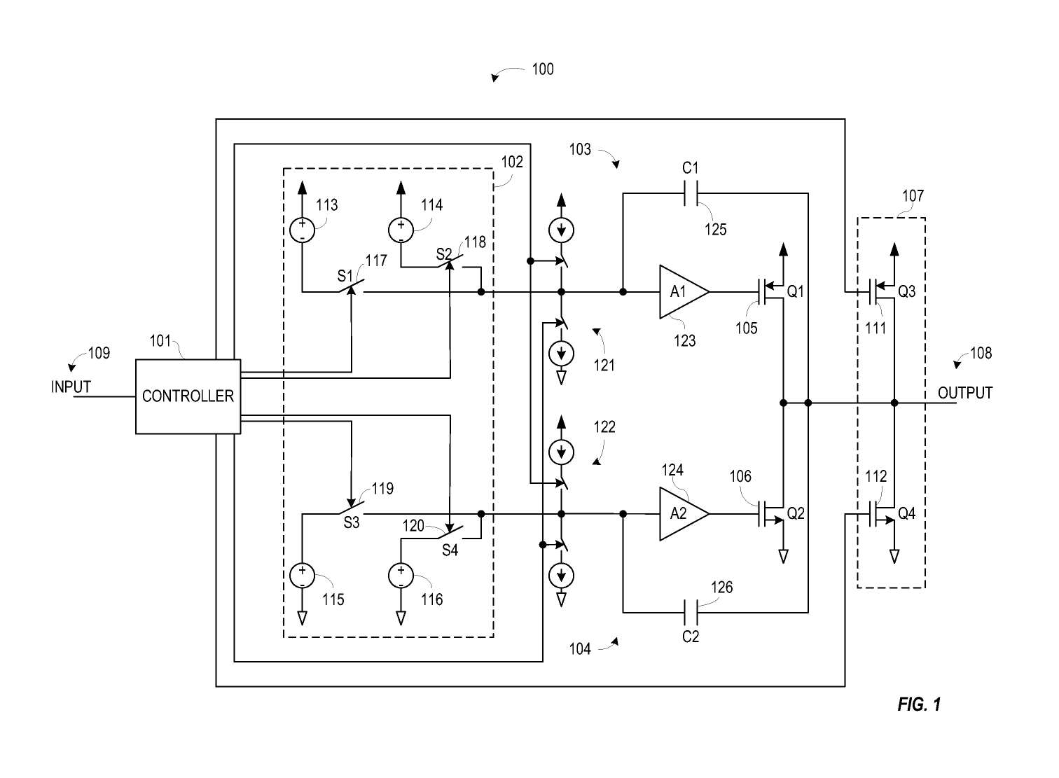

FIG. 1 illustrates generally an example of an output stage 100 of a switching amplifier including a controller 101, voltage tie-offs 102, first and second integrators 103, 104, first and second output devices Q1 105 and Q2 106, and hard switches 107. In an example, the output stage 100 can generate, as an output 108, a representation of the switched input 109. The controller 101 can control the transition rate of the output 108 as it changes steady state levels, while, for example, at the same time, not changing the underlying steady state frequencies of the switched input 109. In certain examples, the output devices Q1 105 and Q2 106 can include transistors, such as metal oxide field effect transistors (MOSFETs).

In an example, the output stage 100 can include hard switches 107, including a first hard switch Q3 111 and a second hard switch Q4 112, that can hold the output at or near a power rail voltage between transitions of the output 108. In an example, the output stage can include the voltage tie-offs 102 to pre-bias the first and second output devices Q1 105 and Q2 106. In certain examples, the voltage tie-offs 102 can include first, second, third, and fourth voltage sources 113, 114, 115, 116 coupled via switches S1 117, S2 118, S3 119, S4 120 to the inputs of the first and second integrators 103, 104. In an example, the first voltage source 113 can provide a voltage of about twice the threshold voltage of the first output device Q1 105. In an example, the second voltage source 114 can provide a sub threshold voltage (e.g., about half the threshold voltage, etc.) of the first output device Q1 105. In an example, the third voltage source 115 can provide a voltage of about twice the threshold voltage of the second output device Q2 106. In an example, the fourth voltage source 116 can provide a sub threshold voltage (e.g., about half the threshold voltage, etc.) of the second output device Q2 106. The voltage tie-offs-can be controlled to pre-bias the first output device Q1 105 in preparation for a transition of the output 108.

For example, as described in U.S. patent application Ser. No. 12/899,810, incorporated herein by reference in its entirety, when the output 108 is high, the first hard switch Q3 111 can be turned on, the second hard switch Q4 112 can be turned off, voltage tie off switches S1 117 and S4 120 can be closed, and voltage tie off switches S2 118 and S3 119 can be open. Conversely, when the output 108 is low, the second hard switch Q4 112 can be turned on, the first hard switch Q3 111 can be turned off, the voltage tie off switches S2 118 and S3 119 can be closed, and the voltage tie-off switches S1 117 and S4 120 can be open. During transitions, the first and second hard switches Q3 111 and Q4 112 can be off, and the integration function, comprised of the switched current sources 121, 122, first and second unity gain buffers A1 123 and A2 124, first and second feedback capacitors C1 125 and C2 126, and the first and second output devices Q1 105 and Q2 106, can produce a controlled voltage ramp of the output 108 in the appropriate direction. For example, the first integrator 103 can include the first unity gain buffer A1 123 and the first feedback capacitor C1 125 coupled to a control node of the first output device 105. The first integrator 103 can control the rate of the output 108 by integrating the voltage applied to the control node of the first output device 105 as the output transitions from a low logic level to a high logic level. In an example, the second integrator 104 can include the second unity gain buffer A2 124 and the second feedback capacitor C2 126 coupled to a control node of the second output device 106. The second integrator 104 can control the rate of change of the output 108 by integrating the voltage applied to the control node of the second output device 105 as the output 108 transitions from the high logic level to the low logic level.

In an example, while the output 108 is high, pre-biasing the first output device Q1 105 into partial conduction, with the second output device Q2 106 biased off but still close to conduction, can prepare the integration function to assume the full load current when the first hard switch Q3 111 turns off and the transition of the output 108 to the opposite (e.g., low) state begins. Correspondingly, while the output 108 is low, pre-biasing the second output device Q2 106 into partial conduction, with the first output device Q1 105 biased off but still close to conduction, can prepare the integration function to assume the full load current when the second hard switch Q4 112 turns off and the transition of the output 108 to the opposite (e.g., high) state begins.

In certain examples, pre-biasing can be improved. First, the first and second unity gain voltage followers (e.g., buffers) A1 123 and A2 124 can be designed for high bandwidth and high current-drive, performance characteristics that can be traded off against other parameters, such as offset. In certain examples, each buffer output voltage can be offset from the corresponding buffer input voltage by 300 mV or more on a DC basis. Buffer offset can make setting appropriate upstream pre-biasing potentials challenging. Second, the pre-bias voltages chosen for the first and second output devices Q1 105 and Q2 106 are approximations. The approximations may not accommodate the magnitude of the current that either device can assume when an output transition event is initiated. For example, when the output stage 100 transitions from hard switch mode (e.g., the first or second hard switches Q3 111 or Q4 112 conducting) into integration mode (e.g., the first or second output devices Q1 105 or Q2 106 assuming full load current conduction), the first and second integration feedback capacitors C1 125 and C2 126 assume adjustment of the gate voltage of the first or second output devices Q1 105 or Q2 106 away from the pre-biased starting point by a potentially significant amount before the respective first or second output device Q1 105 or Q2 106 reaches proper, full load current conduction. This rather rapid loop adjustment can result in a jump in the output 108 that does not lie on the intended linear, edge rate-controlled trajectory.

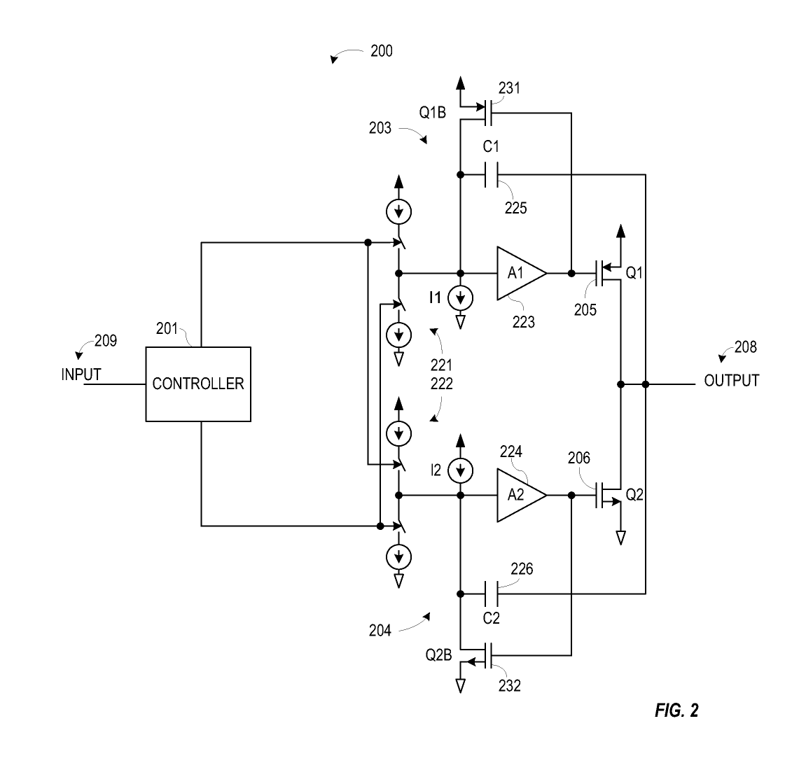

FIG. 2 illustrates generally an example of an improved pre-bias scheme for an output stage 200 of a switching amplifier. The output stage 200 can include a controller 201, first and second integrators 203, 204, and first and second output devices Q1 205 and Q2 206. The output stage 200 can receive a switch input 209 and can provide an edge rate controlled output of the input without a change of the underlying steady state frequencies of the switched input 209. In certain examples, the voltage tie-offs 102 of FIG. 1 can be eliminated. In the example of FIG. 2, hard switch devices, such as illustrated in FIG. 1 as the hard switch devices 107, are not shown. In certain examples, first and second pre-bias devices Q1B 231 and Q2B 232 are lower voltage devices (e.g. thinner oxide) than the first and second output devices Q1 205 and Q2 206.

Correspondingly, first and second pre bias devices Q1B 231 and Q2B 232 can have a lower threshold voltage (Vₜ) than the first and second output devices Q1 205 and Q2 206. Thus, the gate-to-source voltage (V_{gs}) of the first and second pre-bias devices Q1B 231 and Q2B 232, in conduction, can be less than that needed to produce conduction in the first and second output devices Q1 205 and Q2 206, respectively. Between output transitions, while the integration function is idle, and in conjunction with a small amount of bias current supplied by first and second current sources I1 and I2, the voltage at the gate of the first output device Q1 205, V_{g}(Q1), can substantially equal the voltage at the gate of the first pre-bias device Q1B 231, V_{g}(Q1B), and the voltage at the gate of the second output device Q2 206, V_{g}(Q2), can substantially equal the voltage at the gate of the second pre-bias device Q2B 232, V_{g}(Q2B). In an example, because the threshold voltages of the first and second pre-bias devices Q1B 231 and Q2B 232 can be less than the threshold voltages of the first and second output devices Q1 205 and Q2 206 (Vₜ(Q1B,Q2B)<Vₜ(Q1,Q2)), the first and second output devices Q1 205 and Q2 206 can be pre-biased near to, but not actually in, conduction. In certain examples, this pre-biasing can be accomplished even with the offset introduced by first and second buffers A1 223 or A2 224 due to their being enclosed within each respective feedback loop. In certain examples, the inclusion of first and second pre-bias devices Q1B 231 and Q2B 232 can reduce or eliminate the impact of buffer offsets in the pre-biasing scheme, or can establish relatively optimal near-conduction pre-biasing voltages of the first and second output devices Q1 205 and Q2 206 across process, temperature, and operating conditions. In certain examples, the first and second pre-bias devices Q1B 231 and Q2B 232 and the first and second current sources I1 and I2 can be disabled during the output transitions, so as not to interfere with the overall ERC integration function.

In summary, the above-described inclusion of low-Vt first and second pre-bias devices Q1B 231 and Q2B 232 into the pre-biasing scheme can successfully bring both of the first and second output devices Q1 205 and Q2 206 into readiness to rapidly enter conduction when the output stage 200 transitions the output 208.

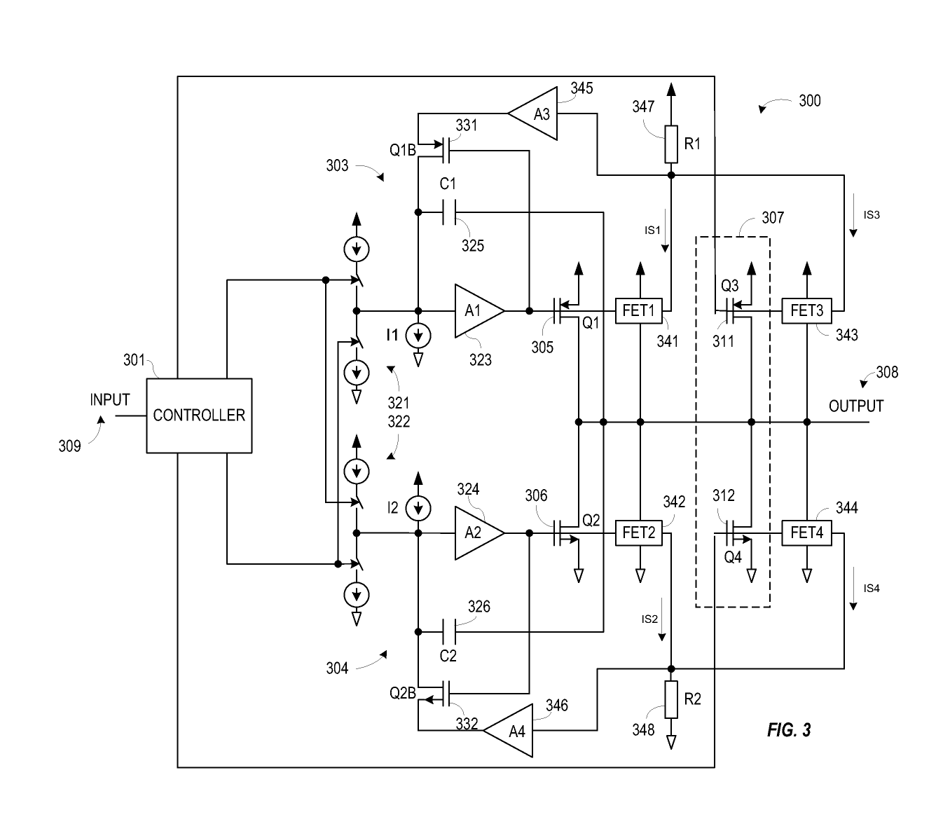

FIG. 3 illustrates generally an example of a switch amplifier output stage 300 including a controller 301, first and second integrators 303, 304, first and second output devices Q1 305 and Q2 306, and hard switches 307. In an example, the output stage 300 can generate an output 308 that is a representation of a switched input 309. The controller 301 can control the transition rate of the output 308 as it changes steady state levels, while, for example, at the same time, the output stage 300 does not change the underlying steady state frequencies of the switched input 309.

In an example, the hard switches 307 can include first and second hard switches Q3 311 and Q4 312 configured to hold the output at a power rail voltage between transitions of output 308.

In certain example, the output stage 300 can provide pre-established conduction corresponding to an assumed load current during transition of the output 308 between voltage states. For example, pre-established conduction can correspond to the instantaneous load current that either of the first or second output devices Q1 305 or Q2 306 can assume at the beginning of an output transition. In certain examples, instantaneous output/load current can be measured and used to an advantage in adjusting the pre-bias voltage(s) prior to an output transition. In certain examples, such as switched output systems (e.g. class-D amplifiers), current information such as output current information, can be measured by sense devices, such as sense field effect transistors (FETs), for the purpose of providing over-current limitation/protection. In certain examples, this same current information can also be used to set the pre-bias voltage(s) such that the control node voltage of the respective output device can be adjusted in proportion to the anticipated load, for example, to assume the actual load current at the onset of an output transition.

In the example illustrated generally in FIG. 3, the inclusion of sense elements FET1 341, FET2 342, FET3 343, FET4 344, third and fourth unity gain buffers A3 345 and A4 346, and resistances R1 347 and R2 348 can assist in providing pre-established conduction. In certain examples, a function of each of the sense elements can include replicating the drain current of its associated power device, such as the first or second output devices Q1 305 or Q2 306 or first and second hard switches Q3 311 and Q4 312, at some small fractional value—for example, 1/10,000^{th}. In certain examples, current IS1 illustrated in FIG. 3 can substantially equal I_{D}(Q1)/10,000, and so forth for currents IS2, IS3, and IS4.

In an example, where the output is low (e.g., the first hard switch Q3 311 is off and the second hard switch Q4 312 is on), and prior to a positive-going output transition, a bias circuit including the second sense element, FET2 342, the fourth sense element FET 4 344, the second resistance R2, 348 and the fourth unity gain buffer 346 can help the second output transistor Q2 306 anticipate the load current before the output 308 changes through the positive-going transition and by allowing the second output transistor Q2 306 to assume at least a substantial fraction of the current supplied by the fourth output transistor Q4 312 prior to the positive-going transition of the output 308. For example, the sense element FET4 344 can send a scaled replica of the drain current (I_{D}) of the second hard switch Q4 312 into resistance R2 348 to establish a voltage across resistance R2 348 proportional to the output load current. The fourth unity gain buffer A4 346 can buffer the voltage across resistance R2 348 and can lift the potential of the source of a second pre-bias device Q2B 332 by the same voltage. The loop comprising the second pre-bias device Q2B 332 and the second unity gain buffer A2 324 can remain closed, and the voltage at the gates of both the second pre-bias device Q2B 332 and the second output device Q2 306 can be elevated by the same potential. If this voltage increase were sufficient to pass the threshold voltage (V) of the second output device Q2 306 and cause conduction, the second output device Q2 306 can begin to assume some of the load current. As the second output device Q2 306 begins to draw some of the load current away from the second hard switch Q4 312, and decrease current IS4, the sense element FET2 342 can proportionally increase current IS2, keeping the sum total of the sensed current being fed into resistance R2 348 accurate. The overall effect of this sensed current action can be to elevate the gate potential of the second output device Q2 306 by an amount that is proportional to the magnitude of current in the output load, effectively pre-biasing the second output device Q2 306 in a load current-dependent fashion, such that at the arrival of an output transition, the second output device Q2 306 can be substantially ready to assume the full load current from the second hard switch Q4 312 since the second hard switch Q4 312 is switched off during the transition. In an example, the second output device Q2 306 can be substantially ready to assume about 90% or more of the load current. In certain examples, the second output transistor Q2 306 can assume all of the load current that up to the point of transition had been shared with the second hard switch Q4 312. This method can allow for less correction via the feedback capacitor C2 326 feedback loop and thereby can produce a smoother, more well behaved (linear), edge rate-controlled output transition.

In the complementary case, where the output is high (e.g., the first hard switch Q3 311 is on and the second hard switch Q4 312 is off), and prior to a negative-going output transition, a corresponding pre-biasing action can occur via a bias circuit including sense elements FET1 341 and FET3 343, resistance R1 347, and the third unity gain buffer A3 345, such that the gate voltage of the first output device Q1 305 is readily biased to handle the output load current when the transition time arrives, providing a more linear slope during a transition of the output 308 from high to low. The bias circuit including sense elements FET1 341 and FET3 343, resistance R1 347, and the third unity gain buffer A3 345, can help anticipate the load current as the output 308 changes through a negative-going transition by allowing the first output transistor Q1 305 to assume at least a substantial fraction of the current supplied by the third output transistor Q3 311 just before the negative-going transition of the output 308. In certain examples, the first output transistor Q1 305 can assume all of the load current that up to the point of transition had been shared with the first hard switch Q3 311.

It is understood that in various examples, the impedances represented by resistances R1 347 and R2 348 can include devices such as, but not limited to, resistors, semiconductor resistors, or MOSFETs wired in gate-drain shorted (MOS diode) configuration. The use of resistors can offer an advantage of allowing the first or second output devices Q1 305 or Q2 306 to be pre-biased with their conduction increasing in square-law fashion in response to increasing output load current. This can be useful in making pre-biasing more responsive to the higher output current levels. Secondly, the absence of output load current (e.g., when currents IS1 through IS4 are equal to 0, can cause the third unity gain buffer A3 345 to draw the source of the first pre-bias device Q1B 331 fully to the positive rail and can further cause the fourth unity gain buffer A4 346 to draw the source of the second pre-bias device Q2B 332 fully to ground. Pulling the source of the second pre-bias device Q2B 332 to ground can keep the gate potentials of the first and second output devices Q1 305 and Q2 306 below their respective threshold voltages (Vₜ), and can reduce a chance of class-A type current flowing from the positive rail through the first and second output devices Q1 305 and Q2 306 into ground, which can otherwise create wasteful power dissipation.

### Additional Notes

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, although the examples above have been described relating to PNP devices, one or more examples can be applicable to NPN devices. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A switch circuit having a first state and a second state, the switch circuit comprising:
first and second output transistors coupled in series, the first output transistor configured to couple an output of the switch circuit to a first voltage during a transition to the first state and the second output transistor configured to couple the output to a second voltage during a transition to the second state;
first and second feedback capacitors coupled to the output of the switch circuit, the first feedback capacitor coupled to a control node of the first output transistor, and the second feedback capacitor coupled to a control node of the second output transistor;
first and second buffers, the first buffer coupled to the control node of the first output transistor and to the first feedback capacitor, and the second buffer coupled to the control node of the second output transistor and the second feedback capacitor; and
a first pre-bias circuit, the first pre-bias circuit comprising:
a first pre-bias current source coupled to an input of the first buffer and to the second voltage; and
a first pre-bias transistor having a control node coupled to an output of the first buffer and to the control node of the first output transistor, the pre-bias transistor configured to selectively couple the input of the first buffer to the first voltage, wherein the first pre-bias transistor includes a lower threshold voltage than the first output transistor.

2. The switch circuit of claim 1 including a second pre-bias circuit, the second pre-bias circuit comprising:
a second pre-bias current source coupled to an input of the second buffer and to the first voltage; and
a second pre-bias transistor having a control node coupled to an output of the second buffer and to the control node of the second output transistor, the second pre-bias transistor configured to selectively couple the input of the second buffer to the second voltage, wherein the second pre-bias transistor includes a lower threshold voltage than the second output transistor.

3. The switch circuit of claim 2, including third and fourth output transistors coupled in series, the third output transistor configured to couple the output of the switch circuit to the first voltage during the first state and the fourth output transistor configured to couple the output to the second voltage during the second state.

4. The switch circuit of claim 3, including a first bias circuit configured to apply a first bias voltage to the control node of the first bias transistor and to the control node of the first output transistor, wherein the first bias voltage is configured to pre-bias the first output transistor to supply current, at a beginning of the transition to the second state, that is at least a substantial fraction of the current supplied by the third output transistor near the end of the first state.

5. The switch circuit of claim 4, wherein the first bias circuit includes a first sense circuit configured to provide a first scaled current indicative of current supplied by the third output transistor near the end of the first state.

6. The switch circuit of claim 5, wherein the first bias circuit includes a first resistor coupled to the first sense circuit, the first resistor configured to generate the first bias voltage using the first scaled current.

7. The switch circuit of claim 6, wherein first bias circuit includes a third buffer coupled to the first resistor and to the first bias transistor.

8. The switch circuit of claim 4, including a second bias circuit configure to apply a second bias voltage to the control node of the second bias transistor and to the control node of the second output transistor, wherein the second bias voltage is configured to pre-bias the second output transistor to supply current, at a beginning of the transition to the first state, that is at least a substantial fraction of the current supplied by the fourth output transistor near the end of the second state.

9. The switch circuit of claim 8, wherein the second bias circuit includes a second sense circuit configured to provide a second scaled current indicative of current supplied by the fourth output transistor near the end of the second state.

10. The switch circuit of claim 9, wherein the second bias circuit includes a second resistor coupled to the second sense circuit, the second resistor configured to generate the second bias voltage using the second scaled current.

11. The switch circuit of claim 10, wherein second bias circuit includes a fourth buffer coupled to the second resistor and to the second bias transistor.

12. A method of pre-biasing a switch circuit, the method comprising:
bringing a first bias transistor into conduction using a first current source;
applying a threshold voltage of the first bias transistor to a control node of a first output transistor, wherein the threshold voltage of the first bias transistor is lower than a threshold voltage of the first output transistor.

13. The method of claim 12 including buffering the first current source from the control node of the first output transistor.

14. The method of claim 12, including:
bringing a second bias transistor into conduction using a second current source;
applying a threshold voltage of the second bias transistor to a control node of a second output transistor, wherein the threshold voltage of the second bias transistor is lower than a threshold voltage of the second output transistor.

15. The method of claim 14 including buffering the second current source from the control node of the second output transistor.

16. The method of claim 12, including applying a voltage indicative of a load current supplied by the switch circuit to a control node of the first bias transistor and to the control node of the first output transistor.

17. The method of claim 16, wherein the applying the voltage indicative of the load current includes sensing the load current of the switch circuit and providing a scaled current representative of the load current.

18. The method of claim 17, including generating the voltage indicative of the load current using a first resistor coupled to the first bias transistor and the scaled current.

19. The method of claim 17, including buffering the voltage indicative of the load current between the first resistor and the first bias transistor.

20. The method of claim 16, including receiving the voltage indicative of the load current at the control node of the first output transistor; and
supplying at least a portion of the load current using the first output transistor.
